(19) United States
(12) Patent Application Publication
(10) Pub. No.: US 2025/0106592 A1
(43) Pub. Date: Mar. 27, 2025

(54) USER VELOCITY TRACKING WITH WIRELESS TECHNOLOGY

(71) Applicant: Samsung Electronics Co., Ltd., Suwon-si (KR)

(72) Inventors: Haofan Lu, Los Angeles, CA (US); Vishnu Vardhan Ratnam, Plano, TX (US); Hao Chen, Allen, TX (US); Lianjun Li, McKinney, TX (US); Pranav Madadi, Sunnyvale, CA (US)

(21) Appl. No.: 18/883,976

(22) Filed: Sep. 12, 2024

Related U.S. Application Data
(60) Provisional application No. 63/540,010, filed on Sep. 22, 2023.

(51) Int. Cl. H04W 4/02; H04B 7/06

(52) U.S. Cl. CPC H04W 4/027; H04B 7/0626

(57) ABSTRACT

Methods and systems for user velocity tracking using wireless technology. A computer-implemented method includes sending one or more frames to one or more transceivers to initiate a process of frame exchanges, receiving, based on the frame exchanges, channel state information (CSI) having one or more CSI impairments, processing the CSI to adjust the one or more CSI impairments of the CSI to generate a plurality of cleaned CSI metrics, and estimating a velocity of a user using the plurality of cleaned CSI metrics.

### CROSS-REFERENCE TO RELATED APPLICATIONS AND CLAIM OF PRIORITY

The present application claims priority to U.S. Provisional Patent Application No. 63/540,010, filed on Sep. 22, 2023. The contents of the above-identified patent documents are incorporated herein by reference.

### TECHNICAL FIELD

The present disclosure relates generally to wireless communication systems. More specifically, the present disclosure relates to a system and method for user velocity tracking using wireless technology.

### BACKGROUND

The Internet of Things (IoT) refers to a network of physical devices, such as vehicles, appliances, and other devices, that are embedded with sensors, software, and network connectivity, allowing them to collect and share data. Such a network may perform user velocity tracking, which typically uses wearable devices that provide user data to the system. User velocity tracking may be used for trajectory tracking and localization of a subject to enable IoT and smart home applications. It can also be used for health-monitoring such as detecting a fall, or gait monitoring of a subject.

However, wearable devices are often expensive, and can be intrusive and uncomfortable. Accordingly, there is a need for systems and methods for improved user velocity tracking that overcome these challenges.

### SUMMARY

The present disclosure relates generally to wireless communication systems and, more specifically, the present disclosure relates to a system and method for user velocity tracking using wireless technology.

In one embodiment, a computer-implemented method is provided. The computer-implemented method includes sending one or more frames to one or more transceivers to initiate a process of frame exchanges, receiving, based on the frame exchanges, channel state information (CSI) having one or more CSI impairments, processing the CSI to adjust the one or more CSI impairments of the CSI to generate a plurality of cleaned CSI metrics, and estimating a velocity of a user using the plurality of cleaned CSI metrics.

In another embodiment, a user velocity tracking system is provided. The user velocity tracking system includes one or more transceivers, and an inference engine including a processor, the processor configured to cause the inference engine to send one or more frames to one or more transceivers to initiate a process of frame exchanges, receive, based on the frame exchanges, CSI having one or more CSI impairments, process the CSI to adjust the one or more CSI impairments of the CSI to generate a plurality of cleaned CSI metrics, and estimate a velocity of a user using the plurality of cleaned CSI metrics.

In yet another embodiment, a non-transitory computer-readable medium is provided. The non-transitory computer-readable medium includes program code, that when executed by at least one processor of an electronic device, causes the electronic device to send one or more frames to one or more transceivers to initiate a process of frame exchanges, receive, based on the frame exchanges, CSI having one or more CSI impairments, process the CSI to adjust the one or more CSI impairments of the CSI to generate a plurality of cleaned CSI metrics, and estimate a velocity of a user using the plurality of cleaned CSI metrics.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example access point according to various embodiments of the present disclosure;

FIG. 2B illustrates an example station according to various embodiments of this disclosure;

FIG. 3 illustrates an example wireless communication system performing user velocity tracking of a subject in an environment according to various embodiments of the present disclosure;

FIG. 4 illustrates a flow chart of an example method for user velocity tracking using channel state information according to various embodiments of the present disclosure;

FIG. 5 illustrates a flow chart of an example signal processing method for processing a channel state information signal according to various embodiments of the present disclosure;

FIG. 6A illustrates a schematic view of a Doppler shift of a channel state information metric according to various embodiments of the present disclosure;

FIG. 6B illustrates an estimation of user velocity using the Doppler shift of FIG. 6A according to various embodiments of the present disclosure;

FIGS. 7A and 7B illustrate an example schematic diagram of user velocity estimation using a path length change rate for each transmitter-receiver pair of a user velocity tracking system according to various embodiments of the present disclosure; and

FIG. 8 illustrates a flow chart of an example channel state information metric processing method for user velocity tracking according to various embodiments of the present disclosure.

### DETAILED DESCRIPTION

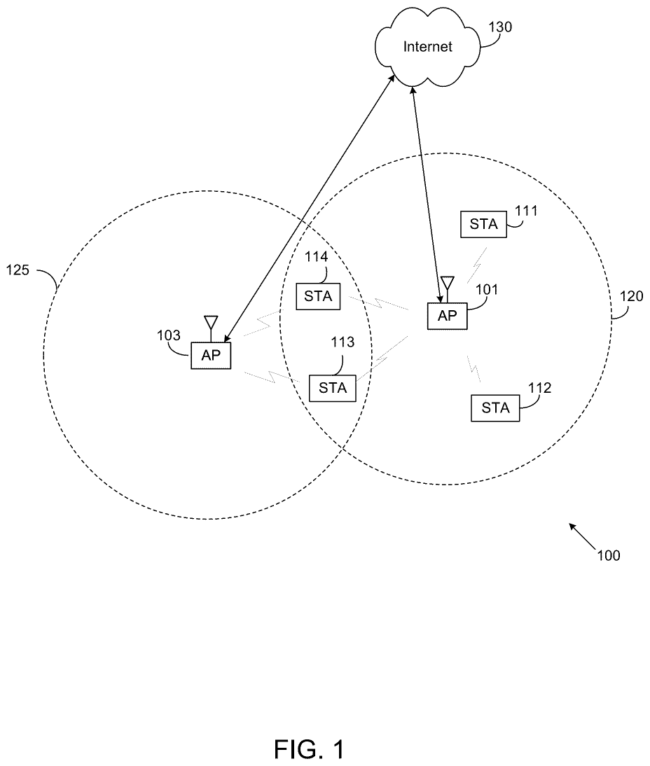

FIG. 1 through FIG. 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, user velocity tracking in a system allows for trajectory tracking and localization of a subject to enable IoT and smart home applications in addition to health-monitoring, such as fall detection and gait monitoring, of a subject. The increase in demand for such applications has also increased demand for wearable devices. Although wearable devices may measure the velocity, e.g., using an inertial motion unit sensor, the wearable devices are often expensive, intrusive, and uncomfortable.

Accordingly, the present disclosure provides systems and methods for wireless user velocity tracking. As described herein, the present disclosure includes a user velocity tracking system that includes a transmitter that periodically transmits a known wireless signal into a channel with the subject that is moving. The system also includes a plurality of receivers to estimate the channel response from their received signal and then observe its temporal variation to predict the velocity of the subject.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for estimating a user velocity based on multi-antenna WiFi signals in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

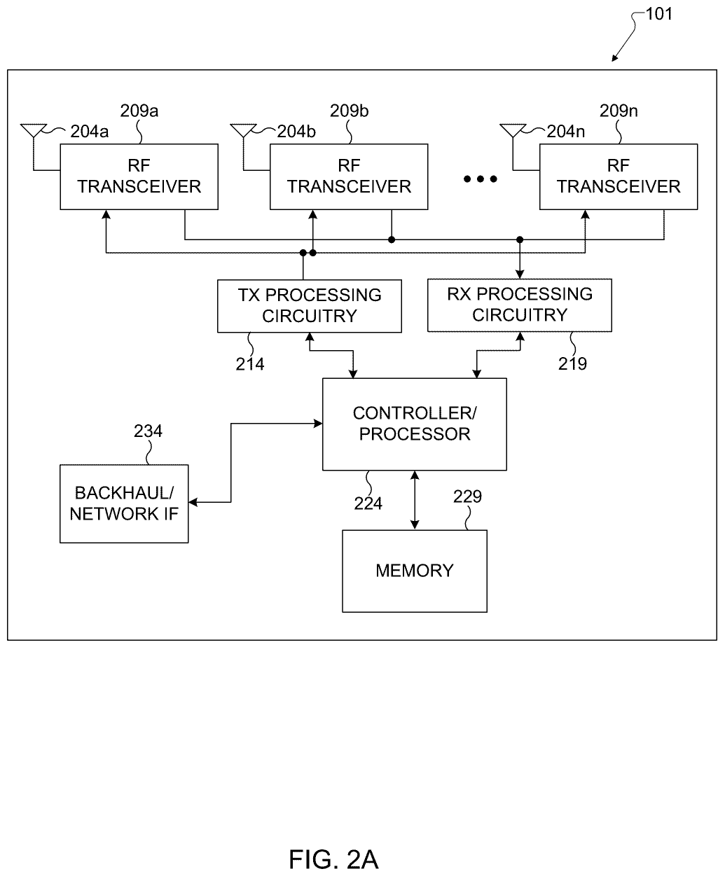

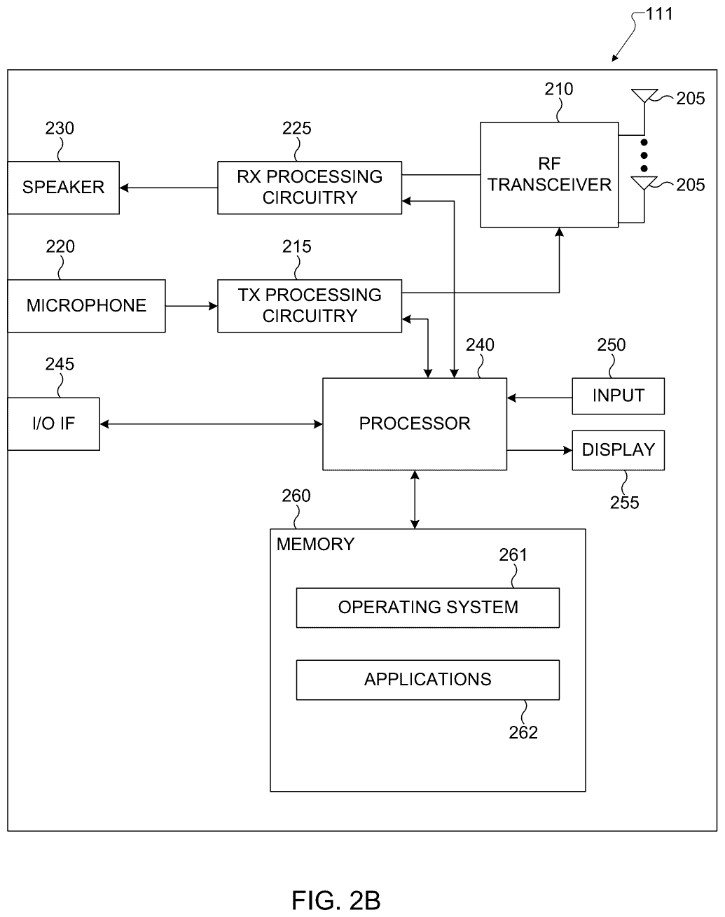

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n, multiple RF transceivers 209a-209n, transmitter processing circuitry 214, and receiver processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the receiver processing circuitry 219, which generates processed baseband signals by filtering, decoding, and/or digitizing the baseband or IF signals. The receiver processing circuitry 219 transmits the processed baseband signals to the controller/processor 224 for further processing.

The transmitter processing circuitry 214 receives analog or digital data (such as voice data, web data, e-mail, or interactive video game data) from the controller/processor 224. The transmitter processing circuitry 214 encodes, multiplexes, and/or digitizes the outgoing baseband data to generate processed baseband or IF signals. The RF transceivers 209a-209n receive the outgoing processed baseband or IF signals from the transmitter processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the receiver processing circuitry 219, and the transmitter processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including estimating a user velocity based on multi-antenna WiFi signals. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for estimating a user velocity based on multi-antenna WiFi signals. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of transmitter processing circuitry 214 and a single instance of receiver processing circuitry 219, the AP 101 could include multiple instances of each (such as one per RF transceiver). In another example, only one antenna and RF transceiver path may be included. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

The STA 111 includes antenna(s) 205, a radio frequency (RF) transceiver 210, transmitter processing circuitry 215, a microphone 220, and receiver processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the receiver processing circuitry 225, which generates a processed baseband signal by filtering, decoding, and/or digitizing the baseband or IF signal. The receiver processing circuitry 225 transmits the processed baseband signal to the speaker 230 (such as for voice data) or to the processor 240 for further processing (such as for web browsing data).

The transmitter processing circuitry 215 receives analog or digital voice data from the microphone 220 or other outgoing baseband data (such as web data, e-mail, or interactive video game data) from the processor 240. The transmitter processing circuitry 215 encodes, multiplexes, and/or digitizes the outgoing baseband data to generate a processed baseband or IF signal. The RF transceiver 210 receives the outgoing processed baseband or IF signal from the transmitter processing circuitry 215 and up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the RF transceiver 210, the receiver processing circuitry 225, and the transmitter processing circuitry 215 in accordance with well-known principles. The processor 240 can also include processing circuitry configured for estimating a user velocity based on multi-antenna WiFi signals. In some embodiments, the controller/processor 240 includes at least one microprocessor or microcontroller.

The processor 240 is also capable of executing other processes and programs resident in the memory 260, such as operations for estimating a user velocity based on multi-antenna WiFi signals. The processor 240 can move data into or out of the memory 260 as required by an executing process. In some embodiments, the processor 240 is configured to execute a plurality of applications 262, such as applications for jointly estimating a user velocity based on multi-antenna WiFi signals. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

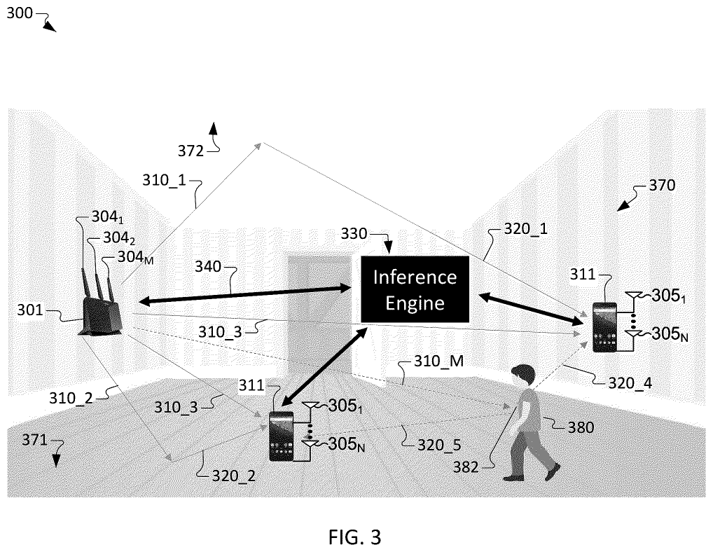

FIG. 3 illustrates an example wireless communication system 300 performing user velocity estimation to determine a user velocity vital sign of a subject in an environment, in accordance with an embodiment of this disclosure. Particularly, the wireless communication system 300 is composed of an AP 301, one or more STAs 311, and an inference engine 330 located in an environment 370, and the wireless communication system 300 performs user velocity estimation to determine the user velocity of the subject 380 located in the environment 370. The embodiment of the wireless communication system 300 shown in FIG. 3 is for illustration only, and other embodiments could be used without departing from the scope of this disclosure. For example, the embodiment of the wireless communication system 300 shown in FIG. 3 could have the same or similar configuration as the network 100 of FIG. 1. The AP 301 and STA 311 of FIG. 3 can have the same or similar configuration as the AP 101 of FIG. 2A and the STA 111 of FIG. 2B, respectively. The M transmitting antennas 3041-304M of the AP 301 can represent antennas of the AP 101 of FIG. 2A. The STA 311 includes N receive antennas, including first antenna 3051 through N-th antenna 305N, which can represent antenna(s) 205 of the STA 111 of FIG. 2B. The wireless communication system 300 includes MN antenna pairs composed from the N receiver antennas respectively paired with each of the M transmitter antennas, and each of the MN antenna pairs indexed by m.

For simplicity, commodity Wi-Fi infrastructure can refer to the AP 301, the STA 311, or the wireless communication system 300 that includes both the AP 301 and the STA 311. The commodity Wi-Fi infrastructure can be modern WiFi devices equipped with multiple antenna elements. Three main features of the commodity Wi-Fi infrastructure according to embodiments of this disclosure will be described, including the features of: (1) obtaining CSI from multi-antenna commodity Wi-Fi infrastructure to estimate a user velocity of the subject 380 using the inference engine 330 based on a system model that is configured to take account for one or more errors in CSI amplitude and one or more errors in the CSI phase; (2) compensating for the one or more errors in the CSI amplitude and the one or more errors in the CSI phase to reconstruct the CSI; and (3) estimating the user velocity of the subject 380 from the reconstructed multi-antenna CSI based on different spatial dimensions of the reconstructed CSI.

As an example, the subject 380, whose velocity will be estimated, is in the vicinity of the STA 311. In the scenario shown, AP 301 transmits to each of the STA 311 (as receivers) a signal 310_1 through 310_M, such as a CSI frame p, from each of the M transmitter antennas. Some of the transmitted signals reflect off a stationary surface of object in the environment 370, such as a ceiling, wall, floor, or furniture. For example, the signal 310_1 transmitted by transmitter antenna 3041 reflects off a ceiling 372; and the signal 310_2 transmitted by transmitter antenna 3042 reflects off a floor 371. As a result, the STA 311 receives reflected signals 320_1 and 320_2, respectively. Some of the transmitted signals reflect off a moving surface of the subject 380 in the environment 370, such as the moving torso (e.g., chest) of a person. For example, the signals 310_M transmitted by the AP 311 are incident upon the moving surface of the subject 380 at an angle θ, relative to a surface plane 382 of the torso. As a result, each of the STA 311 receives different reflected signals, e.g., first reflected signal 320_4 and second reflected signal 320_5. Some of the transmitted signals, such as signal 310_3, are received by the one or more STAs 311 without being reflected at any surface.

Although the example wireless communication system 300 is shown to be configured for WiFi, other configurations of wireless transmission technology are contemplated, including ultra-wideband, short-range wireless technology such as Bluetooth, impulse radio, 5G-NR, and audio transmissions. Note also that the presence of only one subject 380 is exemplary and shall not be construed as a limitation on the embodiments presented in this disclosure. The inference engine 330 may maintain an association, e.g., using inference engine signals 340 capable of transferring data, with the AP 301 and the one or more of the STAs 311, to initiate and supervise the task of velocity tracking. The inference engine 330 includes a processor (not shown) that can include one or more processors or other processing devices that control the overall operation of the inference engine 330 and may perform the methods provided herein. The inference engine 330 can be a separate device such as a personal computation device or can physically be a part of one of the STAs 311. In another embodiment, the transmission and receiving roles may be switched between the AP 301 and the one or more STAs 311, e.g., when the AP 301 or the STAs 311 are transceiver devices, over time as instructed by the inference engine 330. To enable the velocity tracking, the transmitter may transmit a sequence of WiFi frames, based on a schedule indicated by the inference engine 330. The WiFi frame can contain multiple pilot symbols to help the receiver obtain the CSI from each of them. In one embodiment, these WiFi frames can be beacon frames or null data packets, and the transmission can be using orthogonal frequency division multiplexing (OFDM) over K sub-carriers indexed as: [symbol] ={1, . . . , K}.

Although FIG. 3 illustrates an example environment 370 within which a wireless communication system 300 estimates a user velocity of the subject 380, various changes may be made to FIG. 3. Particularly, the presence of only one subject 380 is for simplicity and ease of explanation as an example only, but is not a limitation on the embodiments presented in this disclosure. Multiple subjects 380 may be present in the environment, and the wireless communication system 300 can estimate the velocity of each of the multiple subjects 380, respectively. As another particular example, in one embodiment the transmitter can be an AP and the receiver can be a WiFi STA, or vice versa in another embodiment.

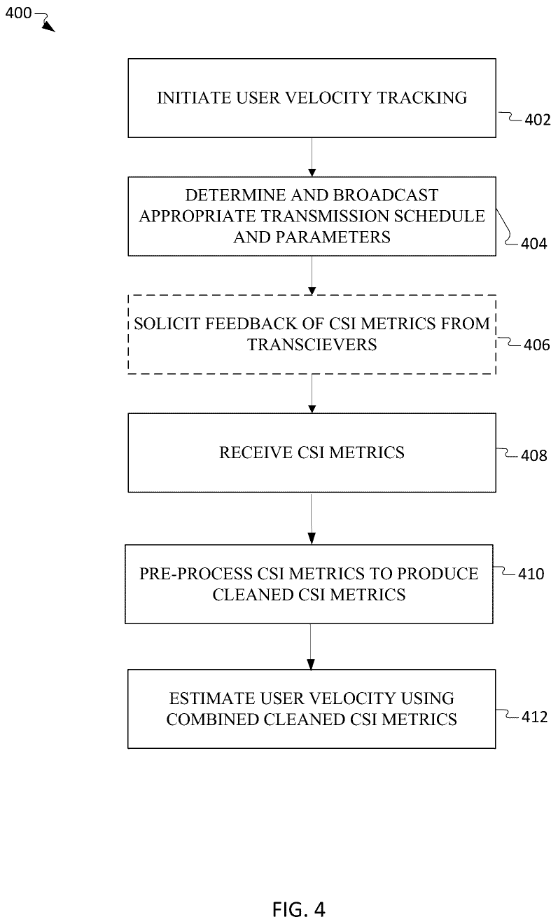

FIG. 4 illustrates a flow chart of an example method 400 for user velocity tracking using channel state information, according to certain embodiments. In particular, the method 400 may be performed by an inference engine, such as the inference engine 330 of FIG. 3, for user velocity tracking in an environment, e.g., the environment 370 of FIG. 3.

The method 400, e.g., user velocity tracking, may be initiated by the inference engine 330 in operation 402. The inference engine 330 determines whether to initiate a process of frame exchanges, e.g., an initial process for velocity estimation, to one or more transceivers, based on a user input, a sensor measurement, or a predetermined environmental condition. For example, the inference engine 330 may receive input from a user to initiate the velocity tracking process. In another example, the inference engine 330 may receive sensor input, e.g., the inference engine may monitor measurements from sensors in the environment 370 to trigger user velocity tracking based on a predetermined threshold. As an example, the inference engine 330 may receive information from a motion detection sensor that detected a subject 380 entering the environment 370 which may cause the inference engine 330 to trigger the velocity tracking. As another example, the inference engine 330 can detect movement from previously collected CSI measurements by devices, e.g., the AP 301 or the one or more STAs 311, under management and trigger the user velocity tracking. In another example, the inference engine 330 may continuously and periodically estimate the velocity of a subject 380 without a trigger.

In operation 404, the inference engine 330 may send a transmission schedule and parameters to be used as well as one or more frames to one or more transceivers, e.g., the one or more STAs 311, to initiate a process of frame exchanges for the user velocity estimation. In one embodiment, initiating the process of frame exchanges includes indicating one or more of inter-packet transmission times to be used, a total duration of the frame exchange sequence, a number of frame exchanges to be performed, a device identifier of transceivers, e.g., the AP 301 or the one or more STAs 311, that will perform the transmission in each instance, a bandwidth of the frames to be used for transmission, appropriate CSI metrics to be computed by the receivers, or a combination thereof.

In optional operation 406, the inference engine 330 may send an explicit frame to solicit the CSI metric feedback, such as desired CSI metrics that are useful or needed to perform user velocity tracking, from the one or more transceivers that are involved in the frame exchange sequence. In another example, each of the one or more STAs 311, may directly forward the computed and stored CSI metrics to the inference engine 330 based on a determined schedule.

In either case, the inference engine 330 receives the requested CSI metrics in operation 408. The CSI metrics received by the inference engine may be pre-processed or “cleaned” to produce cleaned CSI metrics. In another example, the CSI metrics may be unprocessed, and the inference engine may pre-process the raw CSI metrics to produce the cleaned CSI metrics.

In embodiments where the inference engine 330 pre-processes the CSI metrics, the pre-processing involves compensating for, e.g., removing, errors in the CSI metrics due to uncertainty of reception of frames, such as missing frames, or due to synchronization errors and hardware impairments. To produce the cleaned CSI metrics, the CSI metrics may be computed from the measured CSI without any error compensation. The computed CSI metrics can be a function of the measured CSI. For example, the CSI metrics can be one or more of the measured CSI values, the CSI amplitude, the CSI phase, the CSI amplitude quotient from two or more antennas, the phase of CSI quotient from two or more antennas, or a combination thereof.

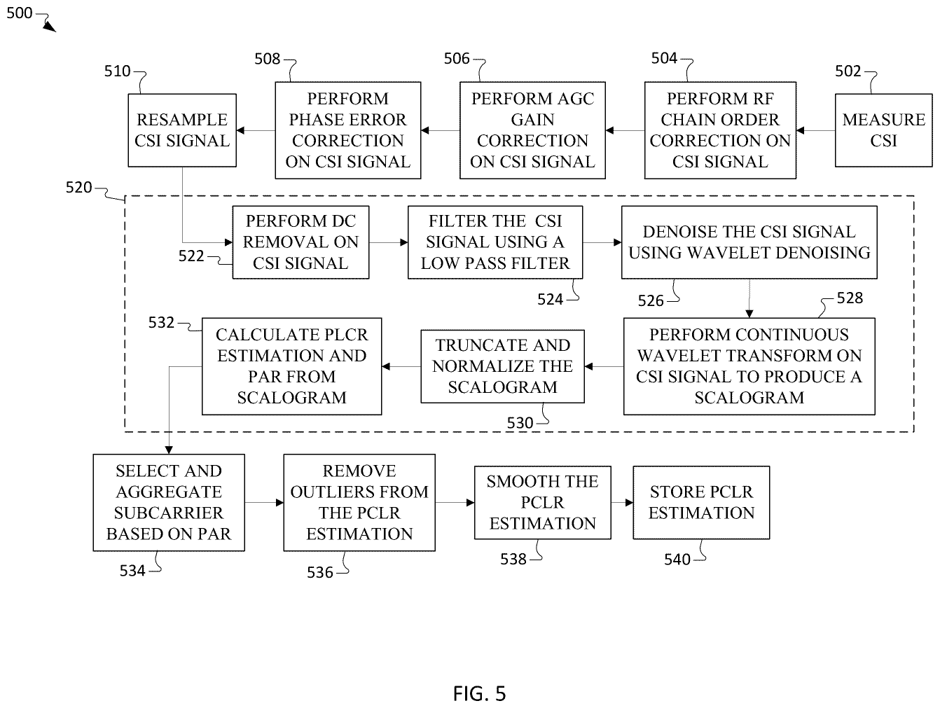

FIG. 5 illustrates a flow chart of an example signal processing method 500 for processing a channel state information signal, according to certain embodiments. In particular, the signal processing method 500 may be performed to pre-process the raw CSI metrics and perform user velocity estimation that may be performed by the inference engine 330 of the wireless communication system 300 of FIG. 3.

In operation 502, raw CSI measurements are collected from each receiver device. The raw CSI measurements obtained by inference engine 330 in operation 502 are often contaminated by one or more CSI impairments in the WiFi transceiver chain. Processing of the CSI is needed to adjust the one or more CSI impairments of the CSI to generate a plurality of cleaned CSI metrics to be used in estimating a velocity of a user. For example, CSI impairments may arise from, in particular, Automatic Gain Control (AGC) circuits that cause amplitude errors in the CSI measurements. Additionally, mis-synchronization between a system transmitter and receiver may cause errors, such as Carrier Frequency Offset (CFO), Sampling Frequency Offset (SFO), and Sampling Time Offset (STO), or a combination thereof. As such, processing the CSI to generate a plurality of cleaned CSI metrics includes correcting one or more CSI impairments may include one or more of operations 504, 506, 508, and 510.

For example, processing the CSI may include correcting the one or more CSI impairments based on radio frequency (RF) chain order correction as in operation 504. For example, the CSI amplitude of consecutive frames is inspected for potentially altered CSI data from two different RF chains. Additional RF chain order correction processes, such as non-linear calibration where a corrective function is used to null distortions, may also be performed in this operation.

In operation 506, an AGC gain correction process is performed on the CSI measurements. For example, the AGC gain error is corrected by normalizing the subcarrier amplitude by the total subcarrier power in a frame. Other AGC gain error correction processes, including closed-loop feedback and calibration methods, may be performed in this operation.

In operation 508, a phase error correction process is performed on the CSI measurements. In this operation, the phase error introduced by CFO, SFO, STO, or a combination thereof is corrected. For example, the CFO may be corrected by estimating the CTO, using analysis of phase differences between signals, then applying a phase rotation to the received signals. The SFO may be corrected, for example, by estimating the phase rotation and amplitude reduction for each subcarrier then applying a phase compensation that depends on the subcarrier index. The STO may be corrected, for example, by using frame detection techniques to estimate the STO and adjusting the sampling points of the received signals. Other suitable methods for phase error correction may also be used in this operation.

In operation 510, the CSI signal is resampled. This operation handles the non-uniform sampling nature of WiFi packets. Resampling generates a uniform sampling grid and interpolates the CSI values at the uniform sampling grid based on the non-uniform samples.

Although shown as part of the signal processing method 500, not all of operations 504-510 need be performed, e.g., one or more of operations 504-510 may be skipped, to produce “cleaned” CSI measurements.

Once the cleaned CSI metrics are produced, the method 400 of FIG. 4 proceeds to estimate user velocity using combined cleaned CSI metrics in operation 412. Referring to FIG. 5, the signal processing method 500 proceeds into a user velocity estimation process with a per-sub-carrier block 520 of operations performed on each sub-carrier of the system. The per-sub-carrier block 520 receives the cleaned CSI metrics and processes the cleaned CSI metrics in preparation for user velocity estimation. For example, the per-sub-carrier block 520 includes operation 522, where a direct current (DC) offset removal process is performed on each sub-carrier. This operation removes the DC component of the CSI signal to avoid interference from DC, reducing noise.

In operation 524, a low pass filtering process is performed. This operation uses low pass filters to remove undesired high-frequency components from the CSI metrics that are not used in subsequent steps of user velocity estimation.

In operation 526, a wavelet denoising process is performed. This operation uses discrete wavelet transform to further remove low-frequency and high frequency noises in the CSI signal. The discrete wavelet transform decomposes the CSI signal into wavelet basis functions that are spatially localized, meaning they are non-zero over only part of the total signal length. These wavelet basis functions form an orthogonal set that may be dilated, translated, and scaled independently and without loss of information. As part of the wavelet denoising process, the wavelet basis functions may undergo thresholding where wavelet coefficients are removed or reduced using soft thresholding or hard thresholding, respectively. Other denoising processes may be performed in this operation.

In operation 528, a signal transform process is performed. For example, a continuous wavelet transform may be performed on the CSI signal. This operation performs continuous wavelet transform to analyze the CSI signal in both time and frequency domain. The operation 528 outputs the scalogram which indicates the signal power at each frequency and time. The CSI metric data from both the current and past several frame exchanges may be used for computing the transform.

The DC offset removal process of operation 524, the wavelet denoising process of operation 526, and the signal transform process of operation 528 allow the processed signals to maintain resolvability in the Doppler and time domains.

In operation 530, truncation and normalization processes are performed on the scalogram produced in operation 528. This operation further removes the redundant scalogram to reduce the processing load of sub-stream modules. For example, truncation may include selecting a portion of the scalogram based on a desired time or frequency range and removing unnecessary or irrelevant portions of the signal. Additionally, normalization may include adjusting the values of each feature based on the feature's minimum and maximum values. In another example, if the continuous wavelet transform is used in operation 528 is used, the continuous wavelet transform may use least absolute deviations or L1 normalization where the amplitudes of the oscillatory components in the signal agree with the amplitudes of the corresponding wavelet coefficients. Other suitable truncation and normalization processes may be performed in this operation.

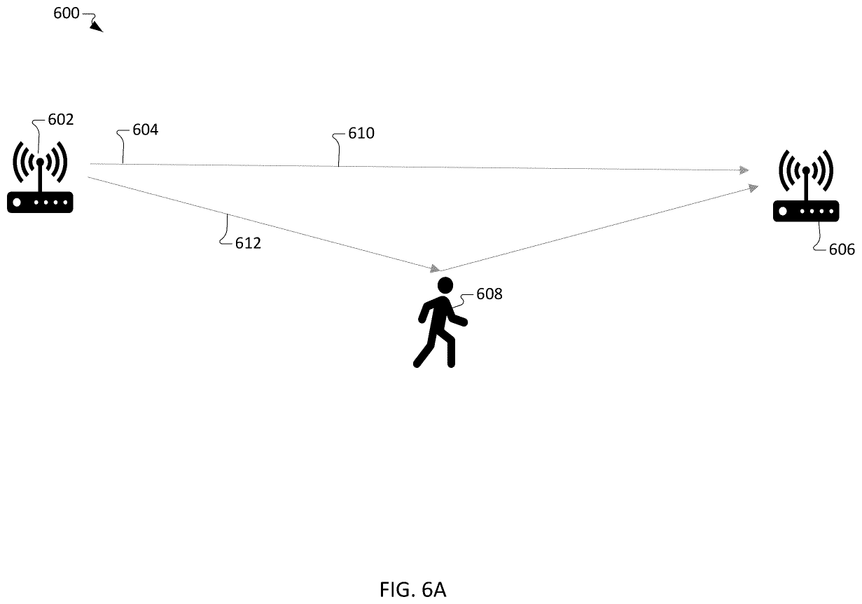

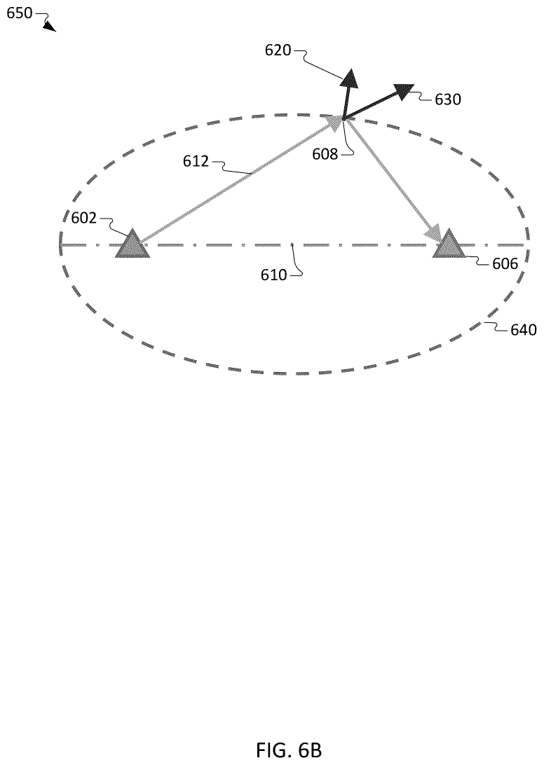

In operation 532, a path length change rate (PLCR) and peak-to-average ratio (PAR) estimation process is performed. This operation calculates the PLCR and extracts a PAR for each of a plurality of subcarriers used for the process of frame exchanges. The PLCR and PAR estimation process is discussed further below in reference to FIGS. 6A and 6B.

FIG. 6A illustrates a schematic view of a Doppler shift of a channel state information metric in an environment 600, according to certain embodiments. FIG. 6B illustrates an example diagram 650 of an estimation of user velocity using the Doppler shift of FIG. 6A, according to certain embodiments. For illustration, consider a WiFi transmitter 602 transmitting a signal 604 and a receiver 606 receiving the signal 604. A movement from a subject 608 causes a Doppler Frequency Shift (DFS) in the signal 604, which can be estimated by proper signal processing of the CSI signal, e.g., from the signal transform process of operation 528, as shown in FIG. 6A.

The DFS in the signal 604 is caused by the change of length d (t) of a reflection path 612 which creates periodic constructive and destructive interference between a Line-of-Sight (LoS) 610 and the reflection path 612. As shown in FIG. 6B, extracting the DFS and further calculating a PLCR 620 can be achieved by performing time-frequency analysis of the CSI measurement over time where the PLCR estimation process is performed using an output, e.g., a scalogram, from the signal transform process of operation 528. The DFS and the PLCR 620 of the signal 604 may be calculated using the following:

$$\begin{matrix}{f}_{D} ( t ) = - \frac{1}{λ} \frac{d}{d t} d ( t ) \\ PLCR = \frac{d}{dt} d ( t ) = {f}_{D} ( t ) * λ ,\end{matrix}$$

where f_{D}(t) is the DFS at time, t, and where λ is the wavelength of the signal 604 used for measurement. The PLCR 620 from one transmitter-receiver pair only gives the projection of the user velocity in the normal direction to an ellipse 640 on which the reflection path 612 lies with transmitter 602 and receiver 606 as the focii as shown in FIG. 6B. The vector sum 630 of the PLCR estimates from multiple transmitter-receiver pairs is taken to obtain the true velocity of the subject 608.

Although operations 522-532 are shown as part of the per-sub-carrier block 520, any combination of these operations may be omitted or performed differently. For example, instead of using a continuous wavelet transform process in operation 528, a short time Fourier transform or Lomb-Scargle Periodogram process may be used.

After processing all sub-carriers through the per-sub-carrier block 520, the signal processing method 500 proceeds to operation 534, where a subcarrier selection and aggregation process is performed based on PAR. In this operation, the inference engine 330 selects a subcarrier of the plurality of subcarriers as a basis for estimating a PLCR estimation value for each timestamp for one or more transmitter-receiver pair of the one or more transceivers. For example, the inference engine 330 may select the subcarrier with the highest PAR, e.g., the ratio of the peak power of the signal its average power, to estimate the PLCR estimation value.

In operation 536, an outlier removal with Hampel filtering process is performed on the PLCR estimation. This operation removes the outliers, e.g., samples that deviate too much from their neighboring samples, to improve accuracy of the PLCR estimation. The Hampel filtering process may include a sliding window of a specified size where a median is calculated. A deviation of each value in the window from the median is calculated and each outlier, a data point that exceeds a predetermined threshold, is replaced with the median value of the window. The Hampel filtering of the operation 536 reduces noise and removes the impact of outliers. Other suitable outlier removal processes may be performed during this operation as well.

Additionally, in operation 538, a smoothing with Savitzky-Golay filtering process is performed. This operation smooths the PLCR estimation and removes high frequency noises. The Savitzky-Golay filtering process of the operation 538 includes a polynomial fitting, where a polynomial is fit to a set of samples within a moving window and used to estimate the smoothed value at the central point of the window, and the use of a set of convolution coefficients applied to all data sub-sets to give estimates of the smoothed signal.

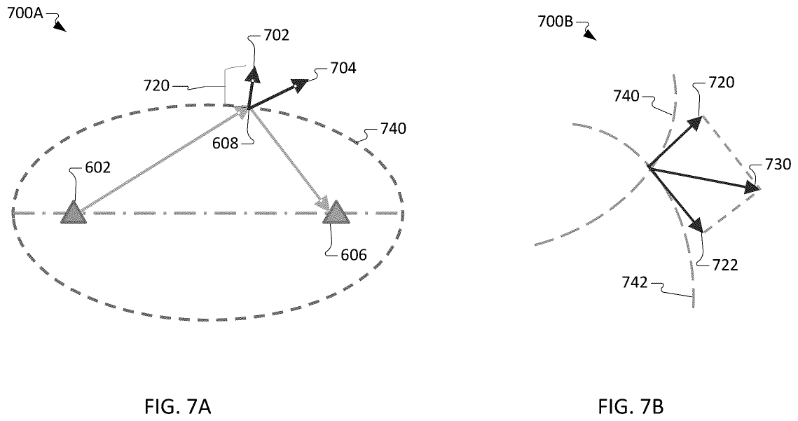

After operation 538, the final PLCR estimation may be stored for user velocity estimation in operation 540 as discussed regarding FIGS. 7A and 7B.

FIGS. 7A and 7B illustrate example diagrams, e.g., diagram 700A and diagram 700B, of user velocity estimation using a PLCR for each transmitter-receiver pair of a user velocity tracking system, according to certain embodiments.

A single PLCR estimation from one transmitter-receiver pair does not accurately represent the velocity of the user. To address this issue, and as shown in FIGS. 7A and 7B, the PLCR estimation values from multiple transmitter-receiver pairs (two shown) are then used jointly to obtain the estimate of the velocity vector 730 of the subject 608. For example, a vector sum of the PLCR estimation from multiple links may be obtained to calculate the velocity of the subject 608. In another example, the PLCR estimation value ρₘ, e.g., a first PLCR estimation value 720, for each transmitter-receiver pair m, e.g., the transmitter 602 and the receiver 606, is converted to a vector \vec{ρₘ}, e.g., a first vector 702, by assigning it the normal direction of the ellipse path, e.g., a first ellipse path 740, corresponding to the transmitter-receiver pair m at the location of the subject 608, as shown in FIGS. 7A and 7B. Similarly, a second PLCR estimation value 722, for a second transmitter-receiver pair (not shown) is converted to a vector by assigning it the normal direction of a second ellipse path 742, corresponding to the second transmitter-receiver pair at the location of the subject 608.

An estimate of the location of the subject 608 may be obtained based on side information or from the results of user trajectory tracking, e.g., vector sum 704 of the first PLCR estimation value 720, from the past frame exchanges. Then, a velocity vector 730, denoted as v, can be found. For example, the velocity vector 730 which minimizes the least squares fit of its projections along the different PLCR vector directions maybe determined using the following:

$$\vec{v} = {arg min}_{{v}^{→︀}} \{ {\sum }_{m = 1}^{M} {W}_{m} \frac{{[ \vert 〈 \vec{v} , \vec{{ρ}_{m}} 〉 \vert - {( {ρ}_{m} )}^{2} ]}^{2}}{{( {ρ}_{m} )}^{2}} \} ,$$

where [symbol] , [symbol] is used to represent the vector inner product and Wm is a combining weight for the transmitter-receiver pair m. This allows for the velocity estimation of operation 412 to use the plurality of cleaned CSI metrics by combining the cleaned CSI metrics of different transmitter-receiver pairs to obtain the velocity estimate.

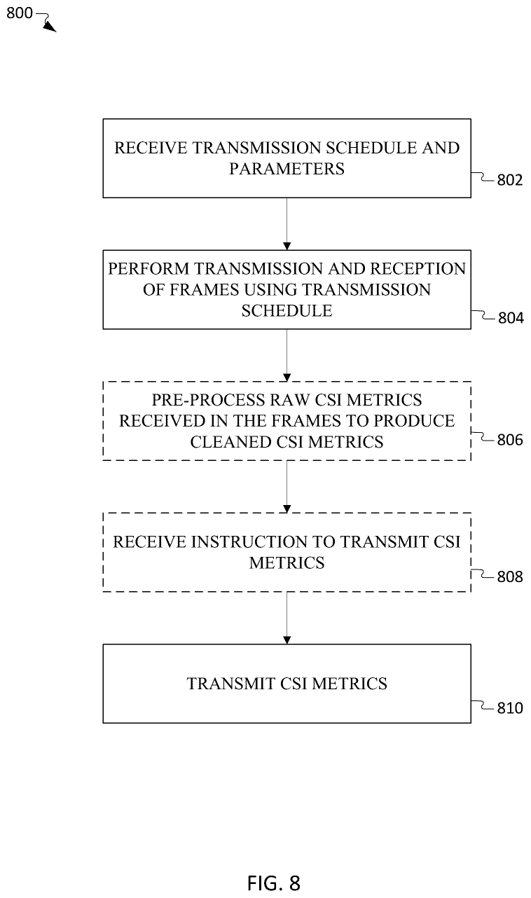

FIG. 8 illustrates a flow chart of an example channel state information metric processing method 800 for user velocity tracking, according to certain embodiments. In particular, the method 800 includes CSI metric processing that may be performed by a transceiver, such as the one or more STAs 311 of FIG. 3, for user velocity tracking in an environment, e.g., the environment 370 of FIG. 3.

The method 800 begins with operation 802 where one or more STAs 311 receive a transmission schedule and parameters, e.g., from the inference engine 330. In operation 804, upon receiving the transmission schedule, each transmitter and receiver under management perform packet transmission and reception according to the schedule and specified parameters in the broadcast frame by the inference engine 330.

Upon receiving the transmission schedule, e.g., from the inference engine 330, each transmitter and receiver under management perform packet transmission and reception according to the schedule and specified parameters in the broadcast frame by the inference engine 330.

In embodiments where the transceiver is tasked with cleaning CSI metrics, the method 800 then proceeds to optional operation 806, where the CSI metrics are pre-processed using similar processes as optional operation 410 of method 400 of FIG. 4, including operations 504-510 of the signal processing method 500, discussed above.

In embodiments where the inference engine 330 explicitly requests the CSI metrics from the transceivers, e.g., the one or more STAs 311, optional operation 808 includes receiving instructions, e.g., from the inference engine 330, to transmit the CSI metrics to the inference engine 330. In operation 810, the CSI metrics are transmitted, e.g., by the transceiver to the inference engine 330, for further processing.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
sending one or more frames to one or more transceivers to initiate a process of frame exchanges;
receiving, based on the frame exchanges, channel state information (CSI) having one or more CSI impairments;
processing the CSI to adjust the one or more CSI impairments of the CSI to generate a plurality of cleaned CSI metrics; and
estimating a velocity of a user using the plurality of cleaned CSI metrics.

2. The method of claim 1, wherein processing the CSI to generate the plurality of cleaned CSI metrics further comprises correcting the one or more CSI impairments based on radio frequency (RF) chain order correction, automatic gain control (AGC) compensation, phase error correction, and resampling of the CSI.

3. The method of claim 1, wherein estimating the velocity of the user using the plurality of cleaned CSI metrics comprises combining the cleaned CSI metrics to obtain the velocity estimate based on direct current (DC) offset removal, wavelet denoising, and wavelet transform to maintain resolvability in Doppler and time domains.

4. The method of claim 1, further comprising:
identifying desired CSI metrics to be included in the CSI received; and
sending information indicating the desired CSI metrics to the one or more transceivers.

5. The method of claim 1, wherein initiating the process of frame exchanges further comprises:
indicating one or more of inter-packet transmission times, total duration of a frame exchange sequence, number of frame exchanges to be performed, a bandwidth of frames to be used for transmission, or a combination thereof.

6. The method of claim 4, further comprising:
sending a frame of the one or more frames to solicit the desired CSI metrics from the one or more transceivers.

7. The method of claim 1, wherein estimating the velocity of the user using the plurality of cleaned CSI metrics further comprises:
performing a signal transform process; and
performing a path length change rate (PLCR) estimation process using an output from the signal transform process.

8. The method of claim 7, wherein estimating the velocity of the user using the plurality of cleaned CSI metrics further comprises:
extracting a peak-to-average ratio (PAR) for each of a plurality of subcarriers used for the process of frame exchanges; and
selecting a subcarrier of the plurality of subcarriers as a basis for estimating a PLCR estimation value for one or more transmitter-receiver pair of the one or more transceivers.

9. The method of claim 8, wherein estimating the velocity of the user using the plurality of cleaned CSI metrics further comprises:
converting the PLCR estimation value for each of one or more transmitter-receiver pairs to a PLCR vector for each of the one or more transmitter-receiver pairs indicating a location of the user; and
determining a velocity vector using the PLCR vector for each of the one or more transmitter-receiver pairs.

10. The method of claim 1, further comprising:
before sending one or more frames to one or more transceivers to initiate a process of frame exchanges, determining whether to initiate the process of frame exchanges based on a user input, a sensor measurement, or a predetermined environmental condition.

11. A velocity tracking system, comprising:
one or more transceivers; and
an inference engine comprising a processor, the processor configured to cause the inference engine to:
send one or more frames to one or more transceivers to initiate a process of frame exchanges;
receive, based on the frame exchanges, channel state information (CSI) having one or more CSI impairments;
process the CSI to adjust the one or more CSI impairments of the CSI to generate a plurality of cleaned CSI metrics; and
estimate a velocity of a user using the plurality of cleaned CSI metrics.

12. The velocity tracking system of claim 11, wherein the inference engine, when estimating the velocity of the user using the plurality of cleaned CSI metrics, is further configured to:
extract a peak-to-average ratio (PAR) for each of a plurality of subcarriers used for the process of frame exchanges; and
select a subcarrier of the plurality of subcarriers as a basis for estimating a PLCR estimation value for one or more transmitter-receiver pair of the one or more transceivers.

13. The velocity tracking system of claim 12, wherein the inference engine, when estimating the velocity of the user using the plurality of cleaned CSI metrics, is further configured to:
convert the PLCR estimation value for each of one or more transmitter-receiver pairs to a PLCR vector for each of the one or more transmitter-receiver pairs indicating a location of the user; and
determine a velocity vector using the PLCR vector for each of the one or more transmitter-receiver pairs.

14. The velocity tracking system of claim 11, wherein the inference engine is further configured to:
before sending one or more frames to one or more transceivers to initiate a process of frame exchanges, determining whether to initiate the process of frame exchanges based on a user input, a sensor measurement, or a predetermined environmental condition.

15. The velocity tracking system of claim 11, wherein the processor, when estimating the velocity of the user using the plurality of cleaned CSI metrics, is further configured cause the inference engine to:
perform a signal transform process; and
perform a PLCR estimation process using an output from the signal transform process.

16. A non-transitory computer-readable medium comprising program code, that when executed by at least one processor of an electronic device, causes the electronic device to:
send one or more frames to one or more transceivers to initiate a process of frame exchanges;
receive, based on the frame exchanges, channel state information (CSI) having one or more CSI impairments;
process the CSI to adjust the one or more CSI impairments of the CSI to generate a plurality of cleaned CSI metrics; and
estimate a velocity of a user using the plurality of cleaned CSI metrics.

17. The non-transitory computer-readable medium of claim 16, wherein the program code, that when executed by the at least one processor, causes the electronic device to initiate the process of frame exchanges, comprises program code, that when executed by the at least one processor, causes the electronic device to:
indicate one or more of inter-packet transmission times, total duration of a frame exchange sequence, number of frame exchanges to be performed, a bandwidth of frames to be used for transmission, or a combination thereof.

18. The non-transitory computer-readable medium of claim 16, wherein the program code, that when executed by the at least one processor, causes the electronic device to estimate the velocity of the user using the plurality of cleaned CSI metrics, comprises program code, that when executed by the at least one processor, causes the electronic device to:
perform a signal transform process; and
perform a path length change rate (PLCR) estimation process using an output from the signal transform process.

19. The non-transitory computer-readable medium of claim 18, wherein the program code, that when executed by the at least one processor, causes the electronic device to estimate the velocity of the user using the plurality of cleaned CSI metrics, comprises program code, that when executed by the at least one processor, causes the electronic device to:
extract a peak-to-average ratio (PAR) for each of a plurality of subcarriers used for the process of frame exchanges; and
select a subcarrier of the plurality of subcarriers as a basis for estimating a PLCR estimation value for one or more transmitter-receiver pair of the one or more transceivers.

20. The non-transitory computer-readable medium of claim 19, wherein the program code, that when executed by the at least one processor, causes the electronic device to estimate the velocity of the user using the plurality of cleaned CSI metrics, comprises program code, that when executed by the at least one processor, causes the electronic device to:
convert the PLCR estimation value for each of one or more transmitter-receiver pairs to a PLCR vector for each of the one or more transmitter-receiver pairs indicating a location of the user; and
determine a velocity vector using the PLCR vector for each of the one or more transmitter-receiver pairs.
